(19) United States
(12) Patent Application Publication
(10) Pub. No.: US 2020/0127351 A1
(43) Pub. Date: Apr. 23, 2020

(54) TWO-PHASE SEMI-IMMERSION THERMAL SYSTEM FOR ENERGY STORAGE AND OTHER ELECTRICAL/ELECTRONIC DEVICES

(71) Applicant: NIO USA, Inc., San Jose, CA (US)

(72) Inventors: Alexander J. Smith, Mountain View, CA (US); Marc W. Juzkow, Livermore, CA (US); Adam H. Ing, San Francisco, CA (US)

(21) Appl. No.: 16/165,401

(22) Filed: Oct. 19, 2018

(51) Int. Cl. H01M 10/6568; H01M 10/613; H01M 10/625

(52) U.S. Cl. CPC H01M 10/6568; H01M 2220/20; H01M 10/625; H01M 10/613

(57) ABSTRACT

A system and method for an energy storage device having improved thermal management is provided. The system includes a number of energy storage cells spaced apart from one another and contained in a housing that can be pressure sealed. The system can include a pipe containing fluid circulating within the pipe and a liquid within the housing, where an amount of the liquid is less than half of a volume within the housing. Thermal energy is transferred between an area within the housing and at least a portion of a wall of the pipe.

### FIELD

The present disclosure is generally directed to energy storage devices, in particular, toward batteries and battery modules for electric vehicles.

### BACKGROUND

In recent years, transportation methods have changed substantially. This change is due in part to a concern over the limited availability of natural resources, a proliferation in personal technology, and a societal shift to adopt more environmentally friendly transportation solutions. These considerations have encouraged the development of a number of new flexible-fuel vehicles, hybrid-electric vehicles, and electric vehicles.

Vehicles employing at least one electric motor and power system store electrical energy in a number of on-board energy storage devices. These vehicle energy storage devices are generally arranged in the form of electrically interconnected individual battery modules containing a number of individual battery cells (e.g., tens, if not hundreds, of battery cells in each of the battery modules). The battery modules are generally connected to an electrical control system to provide a desired available voltage, ampere-hour, and/or other electrical characteristics to a vehicle.

Electric vehicles are dependent on the integrity and reliability of the on board electrical energy power supply and energy storage devices. Thermal conditions can affect the integrity and reliability of the cells, which in turn affects the integrity and reliability of the on-board electrical energy power supply and energy storage devices. As can be appreciated, improvements to thermal systems for managing the temperature of energy storage devices can reduce the chance of failure in the system and extend the lifetime of the system.

### BRIEF DESCRIPTION OF THE DRAWINGS

FIG. 1 shows a cross-sectional view of a battery module in accordance with embodiments of the present disclosure;

FIG. 2 shows a side view of cells within a battery module in accordance with embodiments of the present disclosure;

FIG. 3 shows a first cross-sectional view of a battery module in a cooling mode in accordance with embodiments of the present disclosure;

FIG. 4 shows a second cross-sectional view of a battery module in a cooling mode in accordance with embodiments of the present disclosure; and

FIG. 5 shows a cross-sectional view of a battery module in a heating mode in accordance with embodiments of the present disclosure.

### DETAILED DESCRIPTION

Embodiments of the present disclosure will be described in connection with electrical energy storage devices and, in some embodiments, the construction, structure, and arrangement of components making up a battery module for an electric vehicle drive system.

An electrical energy storage device for a vehicle may include at least one battery including a number of battery modules electrically interconnected with one another to provide electromotive force for the electrical drive system of a vehicle to operate. Each battery module in the at least one battery can include any number of battery cells contained and/or arranged within a battery module housing.

Conventional battery module housings are designed to maximize the number of battery cells contained therein; however, increasing the density of the cells within the module can compound problems of uneven heat distribution within cells and within the module. For example, as cells are charged or fast charged, heat generated during the charging process can negatively affect the cells if the cells become too hot. Increasing the density of the cell arrangement within a module will cause the heat to transfer amongst neighboring cells, thereby compounding the problem. If cells become too hot, they will be damaged. This is why charging, and in particular fast charging, of battery modules can lead to reduced battery (cycle and calendar) life. In addition, cells can heat and cool unevenly, often generating excessive heat within and around the header portion of the cell. To reduce the amount of heat generated during charging, continuous heat transfer between cells while limiting cell temperatures within the module is desired. In addition, environmental conditions (e.g., hot summers and cold winters) can cause damage to cells if the cells become too hot or cold.

Currently, various designs are used to hold the cells within the module and provide thermal management of the cells and/or module. For example, structures with a honeycomb design can be used that are pre-formed structures where the lithium-ion cells are inserted into the open holes within the structure. Various materials, including thermally conductive and insulative materials, may be used for the structure surrounding the cells, including the honeycomb design and fill material. The materials and structures used to hold the cells within the module may be adjusted based on thermal management objectives, and to mitigate the problems of uneven distribution of heat generation within the cells and also mitigate uneven heat distribution within modules.

Problems with choosing materials and designs for thermal management include the need to reduce the mass of battery components in order to improve the gravimetric energy density of the battery because added mass adversely affects the gravimetric energy density of the system. It is generally advantageous to increase the gravimetric energy density of cells and battery modules (as this value directly translates to the gravimetric energy density of battery packs) by increasing the capacity of the cells and/or modules in comparison to their weight to improve the performance of the battery (e.g., by improving the performance of the cells and/or modules). Increases in gravimetric energy density have conventionally been difficult to achieve. Reasons for this include the fact that it can be difficult to decrease the weight of the battery module. As the battery is also one of the largest, heaviest, and most expensive single components of an electric vehicle, any reduction in size and/or weight can advantageously have significant cost savings. Thus, improvements to thermal systems that can increase gravimetric energy density of the battery system are desired.

Conventional systems and methods of providing thermal management systems include the use of a cold plate and/or liquid cooling to manage heat generation. Conventional liquid-based thermal systems for energy storage devices are either indirect liquid cooled or direct liquid cooled. Indirect liquid cooling uses a system of thermal interfaces (e.g., a cold plate) to make contact with the battery cell or other energy storage device. Indirect liquid cooling can be light weight, simple, and robust; however, its thermal performance may be lower than direct liquid cooling. Direct liquid cooling includes systems that fully submerge the energy storage device in a non-conductive fluid (e.g., mineral oil), which allows the fluid to circulate within an enclosure area by means of natural convection or pressure differential (e.g., using a pumping mechanism). Disadvantages of direct liquid cooling include difficulty in balancing the flow of fluid in large systems, and the addition of significant mass to a battery, which reduces the gravimetric energy density. The inventors of the present disclosure have advantageously discovered methods and systems that address these problems of uneven temperature distribution and excessive temperature, while improving the gravimetric energy density of battery modules, as described herein.

Embodiments of the present disclosure will be described in connection with electrical energy storage devices and, in some embodiments, in connection with the construction and structure of components making up a battery module. Embodiments of the present disclosure include systems that have one or more battery modules in combination with one or more heat exchangers.

Although embodiments described herein may be described with respect to an electric vehicle, the present disclosure is not so limited. Various embodiments of the present disclosure can apply to any type of machine using a battery, for example mobile machines including, but not limited to, vertical takeoff and landing vehicles, aircraft, spacecraft, watercraft, and trains, among others.

The present disclosure describes a battery module together with one or more heat exchangers. Although the description herein may use the term “heat exchanger” this description is not limiting, and more than one heat exchanger (of various configurations and materials) may be used. The heat exchanger can include various types of heating and cooling devices and designs (e.g., heat pipes, heat pumps, passive heat exchangers, tube fin, coil, stacked plate, tube/header, or any other type of heat exchanger that allows for condensation of a gas on its surface). The heat exchanger advantageously can enable bi-directional heat transfer between the energy storage devices and the heat exchanger. The heat exchanger can exchange thermal energy (e.g., transfer heat) between various components using one or more modalities, such as phase transition and thermal conduction. Thus, advantageously, the heat exchanger can enable bi-directional heat transfer within the module and/or enable bi-directional heat transfer between the module (including components of the module) and components outside of the module.

Certain embodiments of the present disclosure relate to a module including one or more heat exchangers arranged within the module or adjacent to the module, with the module being partially filled with liquid. The heat exchanger may circulate hot or cool fluids within the heat exchanger to allow bi-directional heat transfer between the heat exchanger and the module. The liquid within the module circulates to transfer thermal energy (e.g., to and from the cells and module components).

In some embodiments, the heat exchanger (or components of the heat exchanger) may be within and/or adjacent to a pressure-sealed system, where the pressure-sealed system promotes phase changes of the liquid, and circulation of the liquid and vapor. For example, a module containing cells may be pressure sealed, with an amount of liquid contained within the module. As the temperature and the pressure of the system increase, vaporization of the liquid within the pressure-sealed system increases and the vapor circulates to the top of the system, where it condenses and falls back onto the components within the system, thereby cooling the components.

Various embodiments of the present disclosure use a non-conductive liquid to provide both cooling and heating functionality in a battery module or battery pack (or other electrical/electronic device) using a two-phase partial immersion thermal design. The system operates under temperature and pressure conditions that allow evaporation at a pre-determined condition to transfer thermal energy between a heat exchanger and an energy storage or electrical/electronic device. In certain aspects, this disclosure reduces the complexity of other systems, simplifies mechanical interfaces (e.g., the cooling plate) and reduces the amount of fluid required. In various aspects, embodiments disclosed herein result in an overall mass reduction that provides higher gravimetric energy density, high thermal performance and increased reliability. Various embodiments allow bi-directional heat transfer where the components are cooled in higher ambient temperature environments and the components are heated in colder environments, thus allowing more uniform temperatures within the module. Battery modules and packs that improve the uniformity of ambient temperature ranges result in increased performance and life and reduced costs (e.g., lesser warranty costs).

Embodiments of the present disclosure advantageously control the temperature of the module. For example, embodiments can advantageously increase the temperature of the module when the module is at an undesirably low temperature, and embodiments can advantageously decrease the temperature of the module when the module is at an undesirably high temperature. In some aspects, when the module (or components of the module) reaches a certain temperature/pressure, the phase change of the liquid and circulation of the liquid and vapor within the system increases due to the changes in temperature/pressure. The phase change and circulation regulates the temperature within the module by transferring energy within the system.

Advantageously, because the circulation happens throughout the module, the system can efficiently heat and cool complex geometries (e.g., modules containing many cells).

In certain aspects, embodiments utilize principles from heat pipes and heat pumps in order to enable bi-directional heat transfer between an energy storage device and a heat exchanger. In various embodiments, the battery cells are only partially submerged in a liquid within the module and the volume containing the liquid and the cells (and other components) is a closed (e.g., pressure-sealed) system.

For example, in a cooling mode, when the battery cells (or other components in contact with the liquid) reach a pre-determined temperature, the surrounding liquid begins to evaporate to a gas. That gas naturally circulates around the enclosure which helps promote homogenous temperature distribution. The gas is then thermally sinked to a cold heat exchanger (a heat exchanger that is externally cooled) where it condenses back into a liquid. The phase change creates a low pressure zone which drives additional gas into contact with the heat exchanger to condense. The condensed liquid then returns to the base of the enclosure where the cycle continues. By having the heat exchanger partially submerged, it also helps to cool the liquid through conduction, which improves the thermal performance of the system.

As another example, in a heating mode, the heat exchanger is externally heated. The heat exchanger transfers heat into the liquid increasing the temperature of the liquid through conduction, which is then transferred to the battery cells. Additionally, the heat may also evaporate some of the liquid which then turns into a gas. This gas then travels to the cells where it condenses on the surface and heats them and turns back into a liquid.

Thus, the same system with heat exchanger can both cool and heat. The system effectively has two modes of transfer to transfer the heat between the heat exchanger and the cells using both the liquid and gaseous states of the fluid. Advantageously, this creates an effective method and system for managing thermal conditions of the module.

The amount of liquid in the module can be any amount; for example, the liquid can have a depth between about 10 to about 40 millimeters. In some embodiments, the liquid can have a depth between about a quarter to about a half of the height of the cells within the module. The amount of liquid may be dependent on trade-offs between gravimetric energy density, cooling/heating design requirements, and a balance of the pressure within the module during evaporation (for example, it may be desirable to maintain the pressure below a pressure that would decrease evaporation). Thus, liquid that is cooler than various system components can circulate around the bottom of the system (e.g., headers of the cells and the busbar in some configurations), and the vapor can circulate at the top of the system. The use of only some liquid in the module (e.g., a partially-filled module) provides lower weight in the module (e.g., versus using a greater amount of liquid) and thereby improves the gravimetric energy density of the module.

Examples of the liquid used in embodiments disclosed herein include Novec™ Engineered Fluids from 3M™, among others. The liquid in the module (in contact with the cells) may be a specially engineered fluid (e.g., 3M™ Novec™ 7100, 7200, 7300 fluids) that is nonconductive (e.g., the liquid is electrically insulating). The liquid may have a volume resistivity of greater than 108 ohm-cm. The liquid can also have any desirable viscosity, heat capacity, and phase change (or other) characteristics. For example, the liquid can boil at low temperature to increase vaporization (e.g., 35-50° C.); however, the boiling temperature would need to be chosen considering the environmental non-operating conditions of the system. Thus, the boiling temperature of the liquid would need to be above non-operating temperatures of the module (including cells). Additionally, although the present disclosure uses the term “liquid,” the liquid may be any one or more types of fluid. As will be appreciated by those of skill in the art, other materials may be employed for the liquid depending on the application. Thermal methods and systems using the liquid may be advantageous in applications where there is complex geometry that needs to have heat transfer because the liquid (and vapor) is able to disperse easily within the complex geometry.

Various components within the module that are in contact with the liquid/vapor may be coated with a dielectric coating. The dielectric coating can be used to protect components, such as the headers of the cells and the weld plates, from degradation due to contact with the liquid. The cell cases, cell headers, busbars, and weld plates, for example, may be coated. The coating may be used on the cells (and other components) regardless of whether the cells are in an inverted position or not. The dielectric coating can protect the cases of the cells from degradation because the cases of the cells are the ground terminal. However, as discussed herein, various components of the module may be made from non-metal materials, such as plastic, and would not need to be coated with a dielectric coating.

Within the module, the cells may be retained in any manner and configuration. In one embodiment, the module may include a lower carrier portion and an upper carrier portion configured to surround one or more battery cells packed in a specific arrangement. The carrier portions may be temporarily joined together at a contacting flange via an adhesive and then permanently interconnected to one another in any manner. The upper and lower carrier portions of the battery module may be configured as thin dielectric (e.g., plastic, composite, or other electrically nonconductive or insulative material, etc.) components that house the battery cells. The cells do not have to be in contact with interior upper and lower surfaces of the module (e.g., interior surfaces of the housing) and can be suspended by the carrier. The cells may be retained, in part or fully, by a structural foam type of material. For example, the cells may be partially surrounded by a sponge material.

In some embodiments, the one, some, or all of the cells may be inverted so that the cells are retained such that cell headers and busbar are immersed in the liquid (e.g., at the bottom side of the module). When in an inverted position, the cell headers may be in contact with the busbar where the cell headers and busbar are all immersed in the liquid. Busbars can generate significant heat and can be cooled more efficiently in a partially filled design when the top of the cells are pointing down. Additionally, within a lithium-ion cell, most of the heat is generated near the top of the cell at the header. Placing the cells inside the fluid reservoir with the headers in the fluid provides more efficient thermal transfer.

In various embodiments, one or more of the cells within the module do not have to be in an inverted position. This may be advantageous to reduce design requirements for the module and to reuse cell containment designs already in use for modules. In some embodiments, the cells may be suspended in a carrier within the module so that they do not touch the bottom of the module.

In various embodiments, surfaces within the system may have non-flat areas to increase and encourage condensation. For example, dimples may be present on one or more surfaces of the system. The dimples may be present in an overhead interior surface of the module, above where cells are arranged, which can advantageously increase condensation and more specifically increase the condensation above where the cells are arranged. Specific positions of the dimples may correspond to positions of each cell in order to cause the condensation to drip down onto each cell. The dimples can be configured with an arrangement, size, and shape to increase condensation and/or to increase the likelihood of condensed liquid dripping down onto certain components (e.g., the cells) as the condensation occurs. Although “dimples” are referred to herein, the non-flat area may have any configuration and shape, such as being textured, having protrusions, having dents or depressions within the surface, having creases, etc.

Heat exchangers as described herein also include passive heat exchangers, such as a heat sink. For example, a heat sink, such as a heater pad, could be located at a bottom exterior side of the module. The heater pad may be used to provide heat to system components when environmental conditions are below a certain temperature.

Certain embodiments of the present disclosure relate to a heat exchanger that includes a heat pipe (e.g., a device that combines thermal conductivity and phase transition to transfer heat between solid interfaces). The term “pipe” as used herein includes a heat pipe. For example, a heat pipe may be located adjacent to a top side of the module. The heat pipe can be in direct contact with a top surface of the module for some or all of the top surface. A surface of the heat pipe may also be a part of the top surface of the module; e.g., the heat pipe may share a surface with the module. The heat pipe may circulate hot or cool fluids within the pipe to allow bi-directional heat transfer between the pipe and the module.

In some aspects, when a heat pipe and a heater pad are used together in the methods and systems of the present disclosure, the hot fluid within the heat pipe inputs heat into the system at the top of the module and the heater pad inputs heat to the cells from the bottom of the module. The heat can cause some of the liquid within the module to be evaporated into a vapor, which can condense on the surfaces of the tops of the cells (e.g., the portions of the cells not immersed in the liquid) to heat the cells and turn back into a liquid. As the temperatures within the module change, the temperature differential causes the liquid and the vapor to circulate and thereby heat or cool the system.

Certain embodiments of the present disclosure relate to a module that includes a heat exchanger with components of the heat exchanger being located within the module. For example, the heat exchanger may have one or more coils located inside of the module with the coil(s) being partially immersed in the liquid that partially fills the module. Each coil may circulate hot or cool fluids within the coil to allow bi-directional heat transfer between the coil and the module (e.g., between the coil and liquid and vapor within the module in contact with the coil).

In various embodiments of the heat exchanger, the hot fluid may be input at the bottom side of the coil (e.g., the side immersed in the liquid) and it heats the liquid in the module. The fluid in the coil cools down as it reaches the top of the coil. The heated liquid in the module circulates around the headers of the cells, and the heated vapor circulates around the tops of the coil. Heating the liquid in the module can cause some of the liquid to be evaporated into a gas, which can condense on the surfaces of the tops of the cells to heat the cells and turn back into a liquid.

In some aspects, when a heat exchanger is used in a heating mode in the methods and systems of the present disclosure, hot fluid is input at the bottom side of the coil (e.g., the side immersed in the liquid) and it heats the liquid in the module. The fluid in the coil cools down as it travels through the coil and reaches the top of the coil. The cells may be inverted, so that the heated liquid in the module circulates around the headers of the cells (and the bottom of the coil), and the heated vapor circulates around the upper portions of the cells (and the top of the coil). Heating the liquid in the module can cause some of the liquid to be evaporated into a vapor, which can condense on the surfaces of the upper portions of the cells (and the top of the coil and upper interior surfaces of the module) to turn back into a liquid. The condensing vapor can drip onto components, such as the cells and the coil, and thereby warm the components. The warm vapor condensing on the upper portions of the cells acts to heat the cells.

In some aspects, when a heat exchanger is used in a cooling mode in the methods and systems of the present disclosure, cold fluid is input at the bottom side of the coil (e.g., the side immersed in the liquid) and it cools the liquid in the module. The fluid in the coil warms up as it travels through the coil and reaches the top of the coil. The cells may be inverted, so that the cooled liquid in the module circulates around the headers of the cells (and the bottom of the coil), and the cooled vapor circulates around the upper portions of the cells (and the top of the coil). Cooling the vapor in the module can cause some of the vapor to condense on the surfaces of the upper portions of the cells (and the top of the coil and upper interior surfaces of the module) to turn back into a liquid. The condensing vapor can drip onto components, such as the cells and the coil, and thereby cool the components. The vapor condensing on the upper portions of the cells acts to cool the cells.

In some aspects, one or more baffles and/or bulkheads may be used to maintain more even liquid levels throughout the module (e.g., reduce sloshing or uneven fluid levels). This may be particularly useful in transportation or mobile applications (e.g., during motion of a vehicle) because the system is only partially filled with liquid. The baffles and/or bulkheads may be attached to one or more surfaces of the module and/or cells (e.g., molded into the bottom of the module) to reduce or control movement of the liquid within the module. The baffles and/or bulkheads may have any configuration and be made of any type of materials. Also, a sponge material may be present in the module to help maintain more even liquid levels within the module. For example, the cells may be partially surrounded by the sponge material that occupies a volume comprising the liquid.

One or more components of the module, including the heat exchanger and the carrier holding the cells can be any type of material or combination of materials, including materials that are lightweight. Examples of materials include, but are not limited to, foams, plastics, other lightweight dielectric materials (e.g., low-density rigid foam, closed-cell foam, open-cell foam, molded plastic, composites, etc.), including aerogels, open cell polyurethane, reticulated polyurethane, open cell polyester, open cell polyamide, and open cell polyether, among others. The material(s) may act as a structural adhesive, thermal conductor, and a dielectric barrier within the battery module.

In some aspects, the compositions of the materials and the amounts of the materials of the heat exchanger materials may be chosen based on a tradeoff between the weight of the material(s) and/or a desired weight of the module and desired thermal properties. For example, the amount(s) of heat exchanger material may be chosen based on a desired thermal profile of the cells, such as an amount required to keep the temperature at the headers of the cells within a specified difference from a temperature at a location on the opposite end of the cells, or to keep the temperatures throughout the cells substantially uniform. Thus, the amount(s) of heat exchanger material may be chosen to prevent hot spots within the cells. In addition, the amount(s) of heat exchanger material may be based on a desired gravimetric energy density of the battery module which would limit the desirability of added mass; for example, limit amounts of the heat exchanger material that are in excess of what is required to obtain a desired thermal profile.

In other aspects, the configurations of the heat exchanger material may be chosen based on the tradeoff between the weight of the material and desired thermal properties. The volumes chosen for the heat exchanger material and the lightweight material may be based on a desired gravimetric energy density of the battery module. Thus, configurations of the heat exchanger material together with the lightweight material may be based on balancing the need to obtain the desired temperatures within all areas of the cells (in particular, the headers of the cells) with the need to improve the gravimetric energy density of the battery module, e.g., by lowering a weight of the module.

In some aspects, the compositions of the materials and the amounts of the materials of the heat exchanger material may be chosen based on a tradeoff between the weight of the material(s) and/or a desired weight of the module and desired thermal properties together with desired electrical properties. Thus, configurations of the heat exchanger material together with the lightweight material may be based on balancing the need for electrical insulation (e.g., by use of material(s) that are electrical insulators) with the need to obtain the desired temperatures within all areas of the cells (in particular, the headers of the cells) and with the need to improve the gravimetric energy density of the battery module, for example by lowering a weight of the module.

The number and configuration of heat exchangers used in the present disclosure is not limited by the description. In various embodiments, there may be only one heat exchanger per module or only one heat exchanger per multiple modules, or in other embodiments, there may be multiple heat exchangers per module. The heat exchangers may be any type of heat exchanger and the types described herein are for illustrative purposes and do not limit the types of heat exchangers that may be used. The heat exchangers may have any design and can include different design features such as dimpled surfaces and fins, and these may be chosen based on design requirements and system needs. For example, surfaces of the heat exchanger at the upper portion of the module may be dimpled to improve condensation on the surfaces. Also, fins may be placed on the heat exchanger in positions within the module that encourage heat transfer. Further, the materials of the heat exchanger are not limited by the description and the heat exchanger may be made out of any type of material (e.g., metal, plastic, etc.), or combination of materials.

In the presently disclosed embodiments, the heat exchanger can be regulated by any method or system and is not limited by the description. For example, the heat exchanger can be regulated by a secondary liquid coolant loop, a refrigerant loop, an air-cooled heat sink (e.g., by convection or forced convection), a thermoelectric device, or a heating pad, among other methods and systems.

In various embodiments, the heat exchangers can be regulated by monitoring and controlling temperatures within the system. The heat exchangers can be regulated by monitoring and controlling temperatures of the cells, including the headers of the cells. The heat exchangers can be regulated by monitoring and controlling temperatures of the hot and/or cold fluids passing through the heat exchanger. In some aspects, the outlet temperature of the fluid is monitored as the controlled variable. The heat exchangers may be used with one or more pumps (e.g., to circulate fluids through the heat exchanger) and/or one or more valves (e.g., to control flow rates through the heat exchanger).

Embodiments disclosed herein are advantageous for various reasons. For example, the heating and cooling methods and systems will work with complex geometries to provide heat transfer throughout the geometry (e.g., via the circulating liquid and vapor). Further, the vapor and liquid each provide a mode of heat transfer for heating and cooling within the system and, unlike conventional systems, the vapor and liquid behave synergistically to provide a more uniform temperature profile not only for a given cell but throughout the module.

Among other things, the present disclosure describes manufacturing methods, construction, and an arrangement of components that fuse together forming a battery module. At least one benefit of the embodiments described herein is observed during thermal events. For example, by interfacing a heat exchanger with a module (e.g., via liquid within a sealed module) in the arrangement described, the thermal differences within the module (e.g., excessive heat generated at the headers of the cells) is distributed across a larger body (e.g., throughout the module) rather than focused on a single battery cell or small group of battery cells. As can be appreciated, this distribution of heat provides a safer and more reliable battery module assembly and battery for a vehicle since it is less likely that one or more cells will be damaged to the extent that it would cause a thermal failure (e.g., a thermal event such as thermal runaway) or a non-passive failure in the energy storage device of the vehicle.

The liquid surrounding the bottom portions of the cells including their headers (in an inverted position) can advantageously absorb a greater amount of thermal energy from the cells during fast charge (versus a lower mass component, such as vapor), and the use of vapor (a lower mass component) surrounding the upper portions of the cells advantageously reduces the mass of the module. As a result, the lower portions of the cells including the cell headers are prevented from heating at a faster rate and/or to a higher temperature than the upper portions of the cells where the vapor is located. Also advantageously, by providing the liquid at only a bottom portion of the cells so that the vapor is provided at an upper portion of the cells (instead of providing the liquid throughout the module or at a greater depth, the overall weight of the module can advantageously be reduced, thereby increasing the gravimetric energy density of the module while simultaneously providing desirable thermal benefits. Said another way, if the liquid filled a greater portion of the volume within the module, then the added mass would problematically reduce the battery module's gravimetric energy density without providing corresponding increases in thermal benefits. Further, in various embodiments, the liquid may also advantageously provide electrical insulation between the cells in addition to providing desirable thermal benefits.

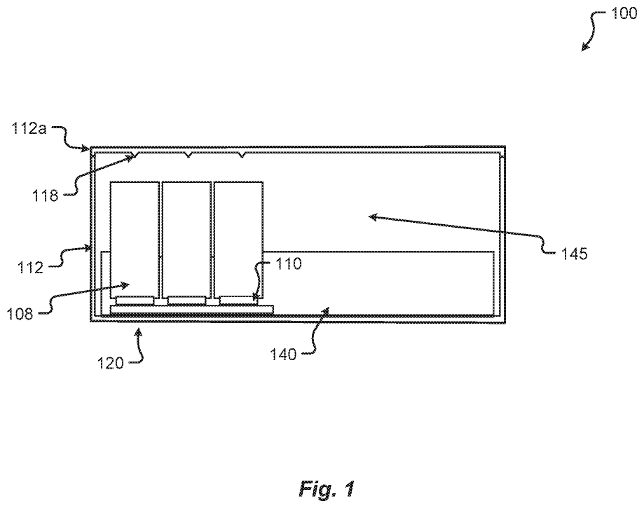

FIG. 1 shows a cross-sectional view of a battery module 100 in accordance with embodiments of the present disclosure. In some embodiments, multiple battery modules 100 may be electrically interconnected via at least one battery busbar including high voltage positive and negative terminals connected to an electrical system of a vehicle. Thus, a battery may be configured as any number of battery modules 100 that are capable of being electrically connected together.

The battery module 100 shown in FIG. 1 is, for example, an electrical energy storage system that is configured to provide the electromotive force needed for the electrical drive system of a vehicle to operate. Although the present disclosure recites batteries, battery modules, and/or battery cells as examples of electrical energy storage units, embodiments of the disclosure should not be so limited. For example, the battery cells, and/or any other energy storage device disclosed herein, may be any electrical energy storage cell including, but in no way limited to, battery cells, capacitors, ultracapacitors, supercapacitors, etc., and/or combinations thereof.

The system shown in FIG. 1 is a battery module 100 that has a housing 112 containing cells 108 with liquid 140 filling a portion of the interior of the housing 112 so that the liquid 140 fills a space between the cells 108 and there is a void space 145 occupying another portion of the interior of the housing 112, as well as some space between the cells 108. In some embodiments, the cells 108 may be suspended in a carrier (not shown) within the housing 112 so that they do not touch the bottom of the housing 112. In the embodiments shown in FIG. 1, the cells 108 are inverted so that their headers 110 are at a bottom side of the housing 112 and submerged in the liquid 140. The headers 110 may be in contact with a busbar 120, which is also submerged in the liquid 140. In various embodiments, the cells 108 do not have to be in an inverted position.

The housing 112 may be sealed using, for example, a lid 112a to form a closed system within the housing 112. As shown, the top interior surface of the lid 112a has dimples 118 on the interior of the surface (e.g., the overhead interior surface of the housing 112). In various embodiments, the dimples 118 are optional and may have any configuration. Although an illustrative configuration of the lid 112a is shown in FIG. 1, this description is not limiting, and embodiments of the lid may not be illustrated in other figures showing further embodiments. For example, any lid of the housing may be described and/or shown as being integral with the housing 112. Thus, the description of the lid 112a is not limiting, and the housing 112 may have any configuration including any type of pressure-sealed container to allow for a closed system within the housing 112.

Although there are three cells 108 in FIG. 1, there may be any number of cells 108 within a housing 112 of the present disclosure, and the cells may be placed in any arrangement within the housing 112. The cells 108 may be any type of cells or combination of cells, including cylindrical, prismatic, and/or pouch cells. Illustrative examples of cylindrical cells that may be used in embodiments disclosed herein include 18550, 26550, and 21700 cell formats, among others.

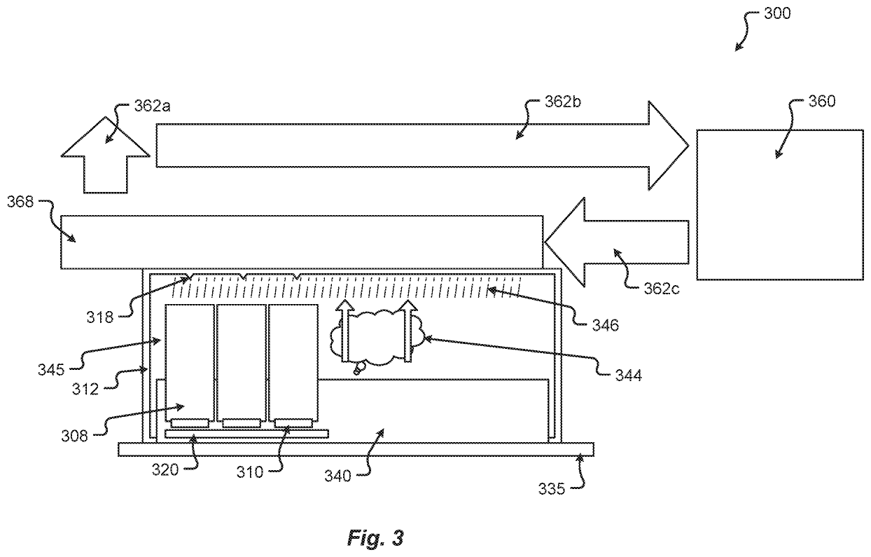

Thus, FIG. 1 shows an illustrative battery module 100 of the present disclosure, and the battery module 100 of FIG. 1 may be combined with systems and methods of transferring heat as described herein, including any number and type of heat exchangers. For example, one or more heat exchangers may be located on the exterior of the housing 112, or within an interior of the housing 112, or may be integrally formed with the housing 112. Thus, although not shown in FIG. 1, the system also includes one or more heat exchangers that provides heating and/or cooling to the system. Further embodiments of battery modules are shown in FIGS. 3-5.

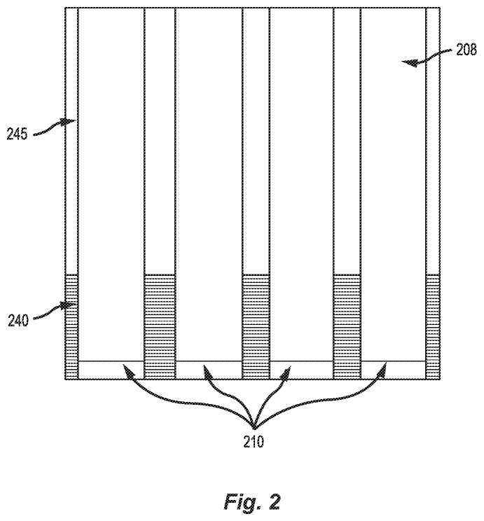

FIG. 2 shows a side view of cells 208 within a battery module in accordance with embodiments of the present disclosure. In FIG. 2, the cells 208 are arranged within the structure so that they are adjacent to one another in a radial direction. The cells 208 are arranged so that a top portion of the cells 208 and their headers 210 are each positioned at a bottom (e.g., lower) portion of the structure so that the cells 208 are in an inverted position within the structure. In various embodiments described herein, the terms “upper” and “top” portion of the cells, as well as the term “header,” may correspond to the positive terminal of the cell. However, in various embodiments of the present disclosure, some or all of the cells 208 do not have to be in an inverted position.

The structure within which the cells 208 are positioned (also referred to herein as a carrier, not shown in FIG. 2) may be any shape and size and have any arrangement of cells 208, including a honeycomb design/pattern or a matrix, for example. Thus, the structure may be referred to herein as a honeycomb or matrix. The structure can resemble a cage or skeleton inside of which the cells 208 are positioned. The structure can be made up of various materials, including plastic materials. In some embodiments, the cells extend from a bottom to a top of the interior of the module, and in other embodiments the cells 208 may be suspended in the carrier within the module so that there is space between the cells 208 and a bottom interior surface of the module (not shown, so that the cells 208 do not touch the bottom interior surface of the module.

As shown in FIG. 2, the structure may be configured to include a void space 245 between the cells 208 and a liquid 240 at the bottom of the structure within the module. Thus, the void space 245 and the liquid 240 occupy a volume between the cells 208. The amount of the liquid 240 within the structure may be any amount. An amount of liquid 240 may be chosen based on one or more criteria, such as a desired depth of the liquid 240 within the module, a desired coverage of surfaces of the cells by the liquid 240, and a desired gravimetric density of the module (e.g., due to the mass of the liquid 240), among other design considerations.

In various embodiments disclosed herein, illustrative depths of the liquid 240 within the module (e.g., heights of the liquid 240 along the sides of the cells 208) range typically from about 5 millimeters to about 50 millimeters, typically from about 10 millimeters to about 40 millimeters, typically from about 15 millimeters to about 35 millimeters, typically from about 20 millimeters to about 30 millimeters, or more typically from about 23 millimeters to about 27 millimeters. Additional illustrative heights of the liquid 240 along the sides of the cells 208 range typically from about a quarter to about a half of the height of the cells 208, or more typically about a third of the height of the cells 208. As discussed herein, the depth of the liquid 240 (e.g., height along the sides of the cells 208) may be dependent on trade-offs between gravimetric energy density, cooling and/or heating design requirements, including temperature and pressure. For example, the pressure within the module may be configured in relation to a desired amount of evaporation. In various embodiments, too high of pressure within the system may disadvantageously decrease evaporation; thus, an amount of pressure may be maintained within the system that advantageously promotes evaporation. Due to the system being a closed system and the evaporation of the liquid, components of the liquid 240 may be in a vapor phase in the void space 245 within the module.

Various components of the system may be in contact with the liquid 240. For example, interior surfaces of the module and components within the module may be in contact with the liquid 240. A dielectric coating may be used to protect the components from degradation due to contact with the liquid, for example because of an increased risk of oxidation from contact with the liquid 240 from differences in electrical potential between various components (e.g., because the casing of the battery cells is the ground terminal). For example, the dielectric coating may be applied to the cell headers 210 and/or weld plates to protect them from degradation. Such a dielectric coating may be applied to any portion of the cells 208, including an entirety of exterior surface areas of the cells 208.

As shown in FIG. 2, the void space 245 and liquid 240 surrounding portions of the cells 208 is in contact with at least portions of side areas of the cells 208, and the liquid 240 may be in contact with side areas of the cells that include an entirety of the cell headers 210. Such configurations can advantageously provide a thermally conductive medium at the bottom portions of the cells 208 (including the header portions of the cells 210) and module where the liquid 240 is located. These portions of the module and cells 208 may be where excessive heat is unevenly generated, especially during charging. The liquid 240 may also advantageously be an electrical insulator. In certain embodiments, the liquid 240 may be configured so that it is only in contact with the cell headers 210 and not other surfaces of the cells 208; thus, it may have a depth or thickness that is limited to correspond to a height of the cell headers 210 within the module. In other embodiments, the liquid 240 may be in contact with a greater portion of the cells, for example, over half the surface area of the cells 208. Advantageously, because an amount of the liquid 240 is limited (e.g., it is in only a portion of the volume of the interior of the module) and not filling an entirety of the volume of the interior of the module, the gravimetric density of the module is improved.

Although the liquid 240 is in only a portion of the volume of the interior of the module, the circulation, evaporation, and condensation of the liquid 240 can advantageously absorb a greater amount of thermal energy from the cells 208 (e.g., during fast charge) than the use of a different medium. For example, as the liquid 240 and vapor in the void space 245 undergo temperature changes and phase changes, the liquid 240 and vapor naturally circulate within the closed system, which helps promote homogenous temperature distribution. In various embodiments, the phase changes create a differential in pressure within the system (e.g., high and low pressure zones), which drive additional liquid 240 and vapor (in the void space 245) into contact with system components, including the heat exchanger(s). The evaporation and condensation move the liquid and vapor between the top and bottom of the system (e.g., where each of the vapor and liquid 240 are located) and the cycle of heating/cooling and evaporating and condensing continues. In certain aspects, by having the heat exchanger partially submerged within the liquid 240 and also present within the vapor (in the void space 245), this improves temperature changes of the vapor and liquid 240 through conduction, which improves the thermal performance of the system. Also, the use of a void space 245 (e.g., a lower mass thermally conductive medium) surrounding the upper portions of the cells 208 advantageously reduces the mass of the module and thereby improves the gravimetric energy density.

In various embodiments, the void space is a substantially-void space, comprising a liquid/gas porous or other permeable structure, within which the battery cells are located. In certain aspects, the liquid/gas porous or other permeable structure of the void space serves to positively locate and/or contain the battery cells while still allowing the coolant to move along the battery cells. For example, the coolant may move within the porous or other permeable structure to circulate along the surfaces of the battery cells.

As a result, the portions of the cells 208 in contact with the liquid 240 (e.g., the cell headers 210 in some embodiments) are prevented from heating at a faster rate and/or to a higher temperature than the upper portions of the cells where the void space 245 is located. Also advantageously, by providing the liquid 240 at only a bottom portion of the cells so that the void space 245 is provided at an upper portion of the cells (instead of providing the liquid 240 throughout the structure, e.g., in contact with an entirety of the surface areas of the cells 208), the overall weight of the module can advantageously be reduced, thereby increasing the gravimetric energy density of the module 100 while simultaneously providing desirable thermal benefits. Said another way, if liquid 240 were in contact with a greater portion of the cell heights (e.g., from a portion extending greater than 50% of the cell heights), then the added mass could problematically reduce the battery module's gravimetric energy density without providing corresponding thermal benefits. In various embodiments, the liquid 240 may also advantageously provide electrical insulation between the cells 208 in addition to providing desirable thermal benefits.

The void space 245 and/or liquid 240 can be any type or combination of fluids. The phase change temperature range of the liquid 240 may be equal to or about equal to a recommended operating temperature or temperature range for the cells 208. Thus, the liquid may be chosen based on a predetermined temperature (e.g., based on a desired temperature or temperature range of the cells 208). Illustrative phase change temperatures of the liquid 240 include typically from about 25° C. to about 65° C., more typically from about 30° C. to about 60° C., more typically from about 33° C. to about 57° C., or more typically from about 35° C. to about 55° C.

Liquids disclosed herein may be free flowing and may be contained or bound, partially or fully, by any type of structure. For example, the liquid may be entrained within a sponge-type of material. The liquid may be physically adsorbed into a carrying matrix, such as a compressed expanded graphite mat or carbon foam. A carrying matrix may be made of any material and have any configuration. If a carrying matrix (e.g., a sponge) is used within the module, excessive movement (e.g., shifting, sloshing, etc.) of the liquid within the module may be advantageously reduced or prevented during movement of the module. The carrying matrix may correspond to the void space (e.g., the liquid/gas porous or other permeable structure), or the carrying matrix may define the void space (e.g., the liquid/gas porous or other permeable structure) or be disposed within the void space (e.g., the liquid/gas porous or other permeable structure).

Thus, as shown by way of example in FIG. 2, embodiments of the present disclosure advantageously provide for battery modules having liquid 240 together with a void space 245 to reduce the mass of the module while at the same time permitting thermal transfer between cells 208 to lower cell temperatures and decrease uneven temperature distribution (including any hot spots) within the cells 208.

FIG. 3 shows a first schematic elevation view of a battery module in a cooling mode in accordance with embodiments of the present disclosure. In certain aspects, FIG. 3 shows a schematic elevation view of an illustrative system 300 with a heat pipe 368 in a cooling mode. In FIG. 3, the system 300 has a pipe 368 adjacent to a top of the housing 312. The pipe circulates fluid 362c from a condenser 360 through the pipe 368 and back to the condenser 360 (e.g., circulating fluid 362a and 362b returning to the condenser 360). The condenser 360 can cool the fluid 362a/362b/362c. For example, in various embodiments, the fluid 362a/362b/362c may undergo a phase change as it moves through the pipe 368, and the condenser 360 cools the fluid 362a/362b/362c to change the phase of the fluid (e.g., the condenser 360 may cool the fluid to condense it from its gaseous state to its liquid state). Although the circulating fluid 362a/362b/362c is shown as arrows in FIG. 3, the pipe 368 may extend in any configuration to contain the fluid 362a/362b/362c and allow the fluid 362a/362b/362c to circulate adjacent to the top of the module, from and to the condenser 360. Thus, the pipe 368 may be in contact with a top surface of the housing 312 or a surface of the pipe 368 may be a part of (e.g., function as) a top surface of the housing 312. The housing 312 may be similar, if not identical, to the housing 112 illustrated and described in conjunction with FIG. 1. The pipe 368 may be made of any material, and is thermally conductive to allow the temperature of the fluid 362a/362b/362c to conduct to the top surface of the module.

The cells 308 are contained within a housing 312 with liquid 340 filling a portion of the housing 312 so that the liquid 340 fills a space between the cells 308 and there is a void space 445 occupying another portion of the space between the cells 308. In some embodiments, the cells 308 may be suspended in a carrier (not shown) within the housing 312 so that they do not touch the bottom of the housing 312. In the embodiments shown in FIG. 3, the cells 308 are inverted so that their headers 310 are at a bottom side of the housing 312 and submerged in the liquid 340. In various embodiments, the cells 308 do not have to be in an inverted position.

The housing 312 may be sealed to form a closed system within the housing 312. Although the cells 308 in FIG. 3 are shown as being present through only less than half of the housing 312, the cells 308 may extend throughout the housing 312 or be in any portion of the housing 312. Also, although only three cells 308 are shown, there may be any number of cells 308 within the housing 312. The bottoms of the cells 308, e.g., the cell headers 310 as shown in the embodiments of FIG. 3, are in contact with a module busbar 320 and the housing 312 is in contact with a heater pad 335. In the illustrative embodiments shown in FIG. 3, the cells 308 are inverted so that the cell headers 310 and the busbar 320 are immersed in the liquid 340.

The system 300 can operate to cool or heat the cells 308. In the configuration of FIG. 3, various components (e.g., one or more of the pipe 368 and/or heater pad 335) enable bi-directional heat transfer between energy storage devices and the pipe 368 and/or heater pad 335. Also, the use of a pressure-sealed system (e.g., the closed system within the housing 312) promotes phase changes of the liquid, and circulation of the liquid and gases.

In the cooling mode, the pipe 368 circulates cool fluid 362a/362b/362c that has been cooled by condenser 360. As the fluid 362a/362b/362c circulates through the pipe 368, the cool fluid 362a/362b/362c draws heat out of the system and increases condensation on the top surface of the module, within the housing 312. In the embodiments shown in FIG. 3, the top interior surface of the housing 312 has dimples 318 on the interior of the top surface (e.g., the overhead interior surface of the housing 312). The dimples 318 can increase condensation by providing an indented surface that causes condensation to form and the liquid to combine and create liquid drops 346 that drip down (e.g., rain falling down) onto the cells 308 and combine with the liquid 340 within the housing 312. In some embodiments, the dimples 318 may provide a focus point or controlled fluid direction area at the top surface of the housing 312, from which the formed condensation may predictably separate and then drip onto the cells 308 disposed below the dimples 318. When the fluid 362a/362b/362c circulating in the pipe 368 is cool (e.g., at a temperature that is cooler than a temperature of other components in the system, for example, a temperature that is cooler than the cells 308), the condensation dripping onto the cells 308 is cool and helps to cool the cells 308. Placement of the dimples 318 can control where condensation occurs so that the condensation is directed to fall down on top of the cells 308 from the dimples 318 (e.g., by lining up dimples 318 with the positions of the cells 308). Also, when the condensation falls back into the liquid 340, it helps to cool the liquid 340, and the liquid 340 cools the headers of the cells 310 and the busbar 320.

In the cooling mode, the heater pad 335 may not provide any heat to the system, or may provide cooling to the system. The heater pad 335 can have any configuration, and may be in direct contact with one or more of the housing 312, the busbar 320, and/or the liquid 340.

The cooling mode of the system 300 can be automated and may be triggered by any criteria. For example, when a temperature of one or more components of the module (e.g., the cells 308, the housing 312, the liquid 340, etc.) increases to be greater than a desired temperature (e.g., a predetermined temperature threshold, etc.), the cooling mode may commence with the fluid 362a/362b/362c circulating in the pipe 368. Also, the fluid 362a/362b/362c may have any temperature and the temperature of the fluid 362a/362b/362c may be adjusted depending on a desired temperature of any one or more components of the module 300 (e.g., a desired operating temperature (or temperature range) of the cells 308). Temperatures may be measured and monitored at any location and for any duration. For example, temperatures of the cells 308, the cell headers 310, the busbar 320, the housing 312, the liquid 340, and/or an inlet and outlet of the pipe 368 may be monitored to adjust the cooling mode (e.g., adjust a flow rate or temperature of the fluid 362a/362b/362c) or adjust a temperature of the heater pad 335.

In some embodiments, the module 300 may have a heating mode. In the heating mode, a temperature of the heater pad 335 may be adjusted and/or a temperature and/or flow rate of the fluid 362a/362b/362c may be adjusted to input heat into the system. For example, as the fluid 362a/362b/362c circulates through the pipe 368, the fluid 362a/362b/362c can input heat into the system. The dimples 318 on the top interior surface of the module 300 can increase condensation by providing a textured surface that causes condensation to form and the liquid 340 to combine and create liquid drops 346 that drip down (e.g., rain falling down) onto the cells 308 and combine with the liquid 340 within the housing 312. When the fluid 362a/362b/362c circulating in the pipe 368 is warm (e.g., warmer than the cells 308), the condensation dripping onto the cells 308 is warm and helps to heat the cells 308. Placement of the dimples 318 can control where condensation occurs so that the condensation is directed to fall down on top of the cells 308 from the dimples 318 (e.g., by lining up dimples 318 with the positions of the cells 308). Also, when the condensation falls back into the liquid 340, it helps to warm the liquid 340, and the liquid 340 warms the headers of the cells 310 and the busbar 320 if the cells 308 are in an inverted position, as shown in FIG. 3. In addition, in the heating mode, the heater pad 335 heats the cells from the bottom of the module and can cause some of the liquid 340 to be evaporated into a gas (e.g., vapor 344), which can condense on the surfaces of the tops of the cells and/or on the upper interior surface of the housing 312 to heat the cells 308 and turn back into a liquid 340. Similarly to the cooling mode, the heating mode of the module 300 can be triggered by any criteria.

Although not shown in FIG. 3, additional embodiments of the disclosure can use baffles and/or bulkheads and/or a sponge material to maintain more even liquid levels throughout the module, particularly during motion of the vehicle. The baffles and/or bulkheads can be molded into the bottom of the module (e.g., to a bottom surface of the housing 312) and can be positioned between any number of cells in any configuration. For example, the baffles and/or bulkheads can be positioned between any number of rows of the cells 308 (e.g., between every two rows of the cells 308). Also, if a sponge is used, the sponge can be positioned within the housing 312 in any manner and configuration. For example, the sponge can be placed around each cell within the housing 312 so that the liquid is entrained within the sponge to contact the cells 308 together with the sponge.

In various embodiments, the module (including the housing 312) is taller than typical modules to promote the phase changes within the housing 312 (e.g., using the dimples 318 present on the upper interior surface of the housing 312) due to extra space being present above the cells 308 (e.g., between the cells 308 and the upper surface of the housing 312). Illustrative distances between the interior top of the housing 312 to a top surface of the cells 308 may minimized, or may be typically from about 1 mm to about 8 mm, more typically from about 2 mm to about 7 mm, or more typically from about 3 mm to about 6 mm.

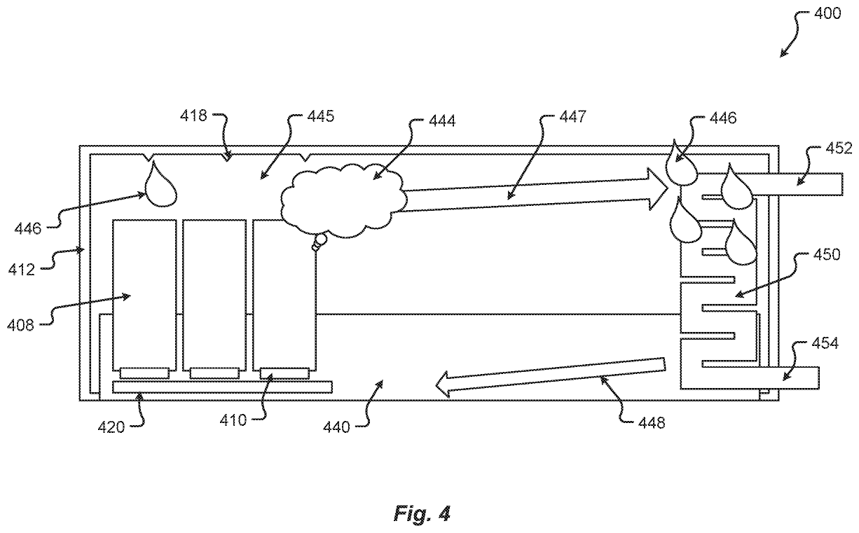

FIG. 4 shows a second schematic elevation view of a battery module in a cooling mode in accordance with embodiments of the present disclosure. In certain aspects, FIG. 4 shows a schematic elevation view of an illustrative system 400 with a heat exchanger in a cooling mode. In FIG. 4, the system 400 has a pipe 450 within the housing 412. The pipe 450 is a heat exchanger, or a portion of a heat exchanger (e.g., fluid in the pipe 450 may be cooled outside of the housing 412 (not shown)), that can have any configuration. In the embodiments of FIG. 4, the pipe 450 has a coil configuration that extends from an inlet 454 of the pipe 450 to an outlet 452 of the pipe 450. The pipe 450 circulates fluid (not shown) through the pipe 450. The pipe 450 may be made of any material, and is thermally conductive.

The cells 408 are contained within the housing 412 with liquid 440 filling a portion of the housing 412 so that the liquid 440 fills a portion of space between the cells 408 and there is a void space 445 occupying another portion of the space between the cells 408. In some embodiments, the cells 408 may be suspended in a carrier (not shown) within the housing 412 so that they do not touch the bottom of the housing 412. The bottoms of the cells 408, e.g., the cell headers 410 as shown in the embodiments of FIG. 4, are in contact with a module busbar 420. In the illustrative embodiment shown in FIG. 4, the cells 408 are inverted so that the cell headers 410 and the busbar 420 are immersed in the liquid 440. In various embodiments, the cells 408 (and busbar 420) do not have to be in an inverted position.

The housing 412 may be sealed to form a closed system within the housing 412. Although the cells 408 in FIG. 4 are shown as being present through only less than half of the housing 412, the cells may extend throughout the housing 412 or be in any portion of the housing 412. Also, although only three cells 408 are shown, there may be any number of cells 408 within the housing 412.

In the cooling mode, the pipe 450 circulates cool fluid, for example fluid that has been cooled by a condenser (not shown). The cool fluid is input at the bottom side of the coil (e.g., the side immersed in the liquid 440) at the inlet 454 to cool down the liquid. The cool temperature of the coil (e.g., a temperature of the coil is less than a temperature within the housing 412) increases condensation on the coil, which drips down to further cool the coil and the liquid 440. The cooled liquid 440 circulates around the headers of the cells 410 and the busbar 420, and the vapor 444 circulates to the top of the coil.

As the fluid circulates through the pipe 450, the cool fluid draws heat out of the liquid 448 and the void space 445 and increases condensation on the upper interior surface of the housing 412 (and the pipe 450 within the housing 412). In the embodiments shown in FIG. 4, the top interior surface of the module 400 has dimples 418 (e.g., the dimples 418 are on the overhead interior surface of the housing 412). The dimples 418 can increase condensation by providing an uneven surface that causes condensation to form and the liquid created by the condensation to combine and create liquid drops 446 that drip down (e.g., rain falling down) onto the cells 408 and also combine with the liquid 440 within the housing 412. When the fluid circulating in the pipe 450 is cool (e.g., cooler than the cells 408), the condensation dripping onto the cells 408 is cool and helps to cool the cells 408. Placement of the dimples 418 can increase control of where the condensation occurs so that the condensation is directed to fall down on the upper portions of the cells 408 from the dimples 418 (e.g., by lining up dimples 418 with the positions of the cells 408). Also, when the condensation falls back into the liquid 440, it helps to cool the liquid 440, and the liquid 440 cools the headers of the cells 410 and the busbar 420.

The dimpled surfaces may be included anywhere in the module, such as the upper interior surface of the housing 412 that is above the pipe 450 to drip the condensation onto the pipe 450, thereby helping to cool the fluid in the pipe 450 prior to the fluid exiting the pipe 450 at the outlet 452. Also, surfaces of the cells 408 and/or the pipe 450 can be dimpled or otherwise textured to increase condensation and direct where the condensation occurs. Condensation occurring on the pipe 450 and/or dripping onto the pipe 450 advantageously lowers the temperature of the pipe 450, and thereby lowers the temperature of the fluid within the pipe 450.

As the cool fluid (e.g., at a temperature cooler than the cells 408) within the pipe 450 through the inlet 454 at the housing, the fluid cools the liquid 440 by conduction through the walls of the pipe 450. The liquid 440, due to various factors such as the change in temperature (and, in some embodiments, the movement of the vehicle), begins to circulate within the housing 412, as shown by the arrow for the liquid circulating 448. As the temperature within the module increases (e.g., the cells 408 heat up), the liquid 440 begins to undergo a phase change and changes to gaseous state (vapor 444). Although the vapor 444 is shown as a certain area within the housing 412, the vapor 444 exists throughout the void space 445 and circulates, as shown by the arrow for vapor circulating 547, within the void space 445 due to temperature changes, pressure changes, phase changes, and movement of the liquid 448 within the module 412. The circulation of the liquid 440 and vapor 444 transfers the energy between the liquid 440 and vapor 444 and the components within the housing 412. The circulation of the liquid 440 and the vapor 444 promotes cooling within the housing 412 to advantageously maintain the cells 408 at a cooler temperature when operating conditions approach or become undesirably hot for the cells 408. Also, the circulation of the liquid 440 and the vapor 444 advantageously helps maintain the cells 408 at a more uniform temperature so that hot spots do not occur (e.g., the headers 410 of the cells 408 do not heat up excessively to create hot spots as compared with the other portions of the cells 408).

The cooling mode of the system 400 can be automated and may be triggered by any criteria. For example, when a temperature of one or more components of the module (e.g., the cells 408, the housing 412, the liquid 440) increases to be greater than a desired temperature, the cooling mode may commence with the fluid beginning to circulate within the pipe 450. Also, the fluid within the pipe 450 may have any temperature and the temperature of the fluid may be adjusted depending on a desired temperature of any one or more components of the system (e.g., a desired operating temperature (or temperature range) of the cells 408). Temperatures may be measured and monitored at any location and for any duration. For example, temperatures of the cells 408, the cell headers 410, the busbar 420, the housing 412, the liquid 440, the inlet 454 of the pipe 450, and/or the outlet 452 of the pipe 450 may be monitored to adjust the cooling mode (e.g., adjust a flow rate or temperature of the fluid within the pipe 450).

In various embodiments, the module 400 (including the housing 412) may be shorter and wider than conventional dimensions (e.g., shorter and wider than the embodiments shown in FIG. 3). Such a configuration may provide space for the heat exchanger 450 within the housing 412. In various embodiments, the heat exchanger size may be application dependent (e.g., it may be selected based on various criteria, such as one or more of how fast of heat transfer is required, how much space is available, and gravimetric density considerations such as how sensitive the application is to mass).

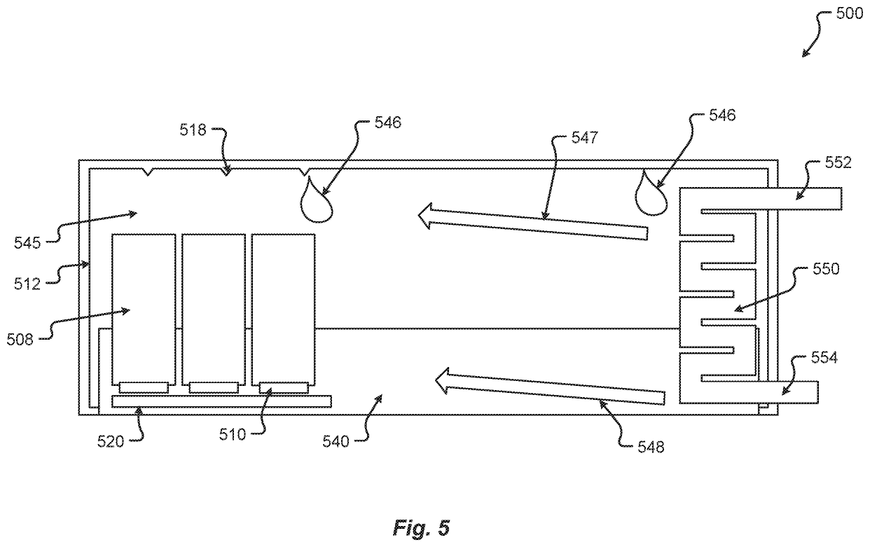

FIG. 5 shows a schematic elevation view of a battery module in a heating mode in accordance with embodiments of the present disclosure. In certain aspects, FIG. 5 shows a schematic elevation view of an illustrative system 500 with a heat exchanger in a heating mode. Components of FIG. 5 may correspond to like components in FIG. 4.

In the heating mode, the pipe 550 circulates warm fluid, for example a fluid that is warmer than a temperature of one or more components of the module (e.g., a temperature of the cells 508, the housing 512, and/or the liquid 540). As the fluid circulates through the pipe 550, the warm fluid inputs heat into the liquid 540 and the void space 545 and increases condensation on the upper interior surface of the housing 512 and the pipe 550 within the housing 512.

As discussed above, the dimples 518 can increase condensation by providing an indented surface that causes condensation to form and the condensed liquid to combine and create liquid drops 5546 that drip down (e.g., rain falling down) onto the cells 508 and combine with the liquid 540 within the housing 512. When the fluid circulating in the pipe 550 is warm (e.g., warmer than the cells 508), the condensation dripping onto the cells 508 may be warmer than the cells 508 and helps to warm the cells 508. Placement of the dimples 518 can control where condensation occurs so that the condensation is directed to fall down on top of the cells 508 from the dimples 518 (e.g., by lining up dimples 518 with the positions of the cells 508). Also, when the condensation falls back into the liquid 540 (e.g., the condensation falls from the cells 508, upper interior surface of the housing 512, and/or the pipe 550 into the liquid 540), it can further warm the liquid 540, and the liquid 540 warms the headers of the cells 510 and the busbar 520.

As described above, the dimpled surfaces may be included anywhere in the housing 512, including the upper interior surface of the housing 512 that is above the pipe 550 to drip the condensation onto the pipe 550, thereby helping to warm the fluid in the pipe 550 prior to the fluid exiting the pipe 550 at the outlet 552. Also, surfaces of the cells 508 and/or the pipe 550 can be dimpled or otherwise textured to increase condensation and direct where the condensation occurs. Condensation occurring on the pipe 550 and/or dripping onto the pipe 550 advantageously raises the temperature of the pipe 550, and thereby raises the temperature of the fluid within the pipe 550.

As the warm fluid (e.g., at a temperature warmer than the cells 508) enters the housing 512 through the inlet 554 to the pipe 550, the warm fluid heats the liquid 540 by conduction through the walls of the pipe 550. The liquid 540, due to various factors, such as the change in temperature and pressure (and potentially the movement of the vehicle), begins to circulate within the housing 512, as shown by the arrow for the liquid circulating 548. As the temperature increases, the liquid 540 begins to undergo a phase change and changes to gaseous state (vapor in the void space 545). The vapor within the void space 545 circulates, as shown by the arrow for vapor circulating 647, due to temperature and pressure changes and movement of the liquid 548 within the module 512. The circulation of the liquid 540 and the vapor promotes warming within the housing 512 to advantageously maintain the cells 508 at a warmer temperature when operating conditions are undesirably cold for the cells 508. Also, the circulation of the liquid 540 and the vapor advantageously helps maintain the cells 508 at a more uniform temperature so that uneven temperature distributions do not occur.

The heating mode of the system 500 can be automated and may be triggered by any criteria. For example, when a temperature of one or more components of the module (e.g., the cells 508, the housing 512, and/or the liquid 540) decreases to be less than a desired temperature, the heating mode may commence with the fluid beginning to circulate within the pipe 550. Also, the fluid within the pipe 550 may have any temperature and the temperature of the fluid may be adjusted depending on a desired temperature of any one or more components of the system (e.g., a desired operating temperature (or temperature range) of the cells 508). Temperatures may be measured and monitored at any location and for any duration. For example, temperatures of the cells 508, the cell headers 510, the busbar 520, the housing 512, the liquid 540, the inlet 554 of the pipe 550, and the outlet 552 of the pipe 550 may be monitored to adjust the heating mode (e.g., adjust a flow rate or temperature of the fluid within the pipe 550).

In various embodiments disclosed herein, the dielectric coating layer(s) may include a material such as IsoEdge™ PR4305. However, the present disclosure does not limit the types and configurations of the additional layers/materials that can be used in embodiments described herein. By way of example, IsoEdge™ PR4305 Heat Plate is a dielectric coated metal substrate that may be placed as a thin coating on various components and provides desirable thermal conductivity and electrical isolation properties. IsoEdge™ PR4305 Heat Plate has a dielectric strength of 550 VAC/mil (per ASTM D149), a thermal impedance of 2.2° C./W (using a TO-220 test method), can have a thickness of 0.004-0.010 of an inch (0.102-0.254 of a mm), a flame rating of VO (as tested per UL 94), a permittivity (dielectric constant) of 6 (per ASTM D150), and a thermal conductivity of 0.6 W/mK (per ASTM D5470).

In various embodiments disclosed herein, a thermal epoxy that may be used includes a material such as LORD Thermoset TC-2002B™ adhesive, which may provide thermal conductivity with a desirable bond strength. The TC-2002B™ has a shelf life (for each component that is six months from the date of manufacture when stored at 25° C. in an original, unopened container, it provides desirable thermal conductivity for applications where superior heat dissipation is required and it can be used on components that experience operating temperatures from −65° C. to +100° C. It has a desirably low coefficient of thermal expansion to reduce the possibility of cracking during wide temperature cycling and is UL Rated for desirable flame retardancy, being UL 94 V-0 certified. It is also advantageously electrically isolative to provide improved isolation for managing current corrosion.

The exemplary systems and methods of this disclosure have been described in relation to a battery module and a number of battery cells in an electric vehicle energy storage system. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others. In some embodiments, the present disclosure provides an electrical interconnection device that can be used between any electrical source and destination. While the present disclosure describes connections between battery modules and corresponding management systems, embodiments of the present disclosure should not be so limited.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, although the description of the disclosure has included a description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a battery module, including: a housing including a base surface, a top surface, and sidewalls extending from a periphery of the base, where the sidewalls, the top surface, and the base define a containment cavity having a volume, and where the housing is sized to receive a battery cell; an array of battery cells at least partially disposed within the housing; a pipe containing fluid circulating within the pipe; and a liquid within the housing, where an amount of the liquid is less than half of the volume, and where thermal energy is transferred between an area within the housing and at least a portion of a wall of the pipe.

Aspects of the above battery module further include where the containment cavity is a pressure-sealed cavity. Aspects of the above battery module further include where fluid circulating within the pipe is on an outer side of the top surface of the housing and where the top surface includes the portion of the wall of the pipe or the top surface is in contact with the portion of the wall of the pipe. Aspects of the above battery module further include where an interior surface of the housing includes dimples. Aspects of the above battery module further include where each one of the dimples align in a vertical direction with each one of the battery cells in the array of battery cells. Aspects of the above battery module further include a condenser connected to the pipe, where the fluid circulates through the condenser. Aspects of the above battery module further include where a temperature of the fluid exiting the condenser is cooler than a temperature of at least one of the battery cells. Aspects of the above battery module further include a heater pad adjacent to the base surface of the housing, where a temperature of the fluid is warmer than a temperature of at least one of the battery cells, and where a temperature of the heater pad is warmer than the temperature of the at least one of the battery cells. Aspects of the above battery module further include where a portion of the pipe is within the containment cavity. Aspects of the above battery module further include where the portion of the pipe is partially immersed within the liquid. Aspects of the above battery module further include where a temperature of the fluid at an inlet of the portion of the pipe is lower than a temperature at an outlet of the portion of the pipe, and where the inlet is immersed within the liquid. Aspects of the above battery module further include where an interior surface of the housing includes dimples. Aspects of the above battery module further include where the interior surface is at least a portion of the top surface and at least a portion of the wall of the pipe that is not immersed in the liquid.

Embodiments include an energy storage device, including: a housing including a base surface, a top surface, and sidewalls extending from a periphery of the base, where the sidewalls, the top surface, and the base define a containment cavity having a volume, and where the housing is sized to receive a battery cell; an array of battery cells at least partially disposed within the housing; a pipe containing fluid circulating within the pipe; and a liquid within the housing, where an amount of the liquid is less than half of the volume, and where thermal energy is transferred between an area within the housing and at least a portion of a wall of the pipe.

Aspects of the above energy storage device further include where the containment cavity is a pressure sealed cavity. Aspects of the above energy storage device further include where fluid circulating within the pipe is on an outer side of the top surface of the housing and where the top surface includes the portion of the wall of the pipe or the top surface is in contact with the portion of the wall of the pipe. Aspects of the above energy storage device further include where an interior surface of the housing includes dimples. Aspects of the above energy storage device further include where each one of the dimples align in a vertical direction with each one of the battery cells in the array of battery cells. Aspects of the above energy storage device further include a condenser connected to the pipe, where the fluid circulates through the condenser. Aspects of the above energy storage device further include where a temperature of the fluid exiting the condenser is cooler than a temperature of at least one of the battery cells. Aspects of the above energy storage device further include a heater pad adjacent to the base surface of the housing, where a temperature of the fluid is warmer than a temperature of at least one of the battery cells, and where a temperature of the heater pad is warmer than the temperature of the at least one of the battery cells. Aspects of the above energy storage device further include where a portion of the pipe is within the containment cavity. Aspects of the above energy storage device further include where the portion of the pipe is partially immersed within the liquid. Aspects of the above energy storage device further include where a temperature of the fluid at an inlet of the portion of the pipe is lower than a temperature at an outlet of the portion of the pipe, and where the inlet is immersed within the liquid. Aspects of the above energy storage device further include where an interior surface of the housing includes dimples. Aspects of the above energy storage device further include where the interior surface is at least a portion of the top surface and at least a portion of the wall of the pipe that is not immersed in the liquid.

Embodiments include a battery for an electric vehicle, including: a plurality of battery modules electrically interconnected with one another, where each battery module of the plurality of battery modules includes: a housing including a base surface, a top surface, and sidewalls extending from a periphery of the base, where the sidewalls, the top surface, and the base define a containment cavity having a volume, and where the housing is sized to receive a battery cell; an array of battery cells at least partially disposed within the housing; a pipe containing fluid circulating within the pipe; and a liquid within the housing, where an amount of the liquid is less than half of the volume, and where thermal energy is transferred between an area within the housing and at least a portion of a wall of the pipe.

Aspects of the above battery further include where the containment cavity is a pressure sealed cavity. Aspects of the above battery further include where fluid circulating within the pipe is on an outer side of the top surface of the housing and where the top surface includes the portion of the wall of the pipe or the top surface is in contact with the portion of the wall of the pipe. Aspects of the above battery further include where an interior surface of the housing includes dimples. Aspects of the above battery further include where each one of the dimples align in a vertical direction with each one of the battery cells in the array of battery cells. Aspects of the above battery further include a condenser connected to the pipe, where the fluid circulates through the condenser. Aspects of the above battery further include where a temperature of the fluid exiting the condenser is cooler than a temperature of at least one of the battery cells. Aspects of the above battery further include a heater pad adjacent to the base surface of the housing, where a temperature of the fluid is warmer than a temperature of at least one of the battery cells, and where a temperature of the heater pad is warmer than the temperature of the at least one of the battery cells. Aspects of the above battery further include where a portion of the pipe is within the containment cavity. Aspects of the above battery further include where the portion of the pipe is partially immersed within the liquid. Aspects of the above battery further include where a temperature of the fluid at an inlet of the portion of the pipe is lower than a temperature at an outlet of the portion of the pipe, and where the inlet is immersed within the liquid. Aspects of the above battery further include where an interior surface of the housing includes dimples. Aspects of the above battery further include where the interior surface is at least a portion of the top surface and at least a portion of the wall of the pipe that is not immersed in the liquid.

Embodiments include an energy storage device, including: a housing including a base surface, a top surface, and sidewalls extending from a periphery of the base surface, where the sidewalls, the top surface, and the base surface define a containment cavity, and where the housing is sized to receive a battery cell; an array of battery cells at least partially disposed within the housing; a pipe containing fluid circulating within the pipe; and a liquid and a void space within the housing, wherein at least a portion of each of the liquid and the void space is in contact with each battery cell in the array of battery cells, and where thermal energy is transferred between each of the liquid and the void space and at least a portion of a wall of the pipe.

Aspects of the above energy storage device further include where the containment cavity is a pressure sealed cavity. Aspects of the above energy storage device further include where fluid circulating within the pipe is on an outer side of the top surface of the housing and where the top surface includes the portion of the wall of the pipe or the top surface is in contact with the portion of the wall of the pipe. Aspects of the above energy storage device further include where an interior surface of the housing includes dimples. Aspects of the above energy storage device further include where each one of the dimples align in a vertical direction with each one of the battery cells in the array of battery cells. Aspects of the above energy storage device further include a condenser connected to the pipe, where the fluid circulates through the condenser. Aspects of the above energy storage device further include where a temperature of the fluid exiting the condenser is cooler than a temperature of at least one of the battery cells. Aspects of the above energy storage device further include a heater pad adjacent to the base surface of the housing, where a temperature of the fluid is warmer than a temperature of at least one of the battery cells, and where a temperature of the heater pad is warmer than the temperature of the at least one of the battery cells. Aspects of the above energy storage device further include where a portion of the pipe is within the containment cavity. Aspects of the above energy storage device further include where the portion of the pipe is partially immersed within the liquid. Aspects of the above energy storage device further include where a temperature of the fluid at an inlet of the portion of the pipe is lower than a temperature at an outlet of the portion of the pipe, and where the inlet is immersed within the liquid. Aspects of the above energy storage device further include where an interior surface of the housing includes dimples. Aspects of the above energy storage device further include where the interior surface is at least a portion of the top surface and at least a portion of the wall of the pipe that is not immersed in the liquid.

Embodiments include a battery for an electric vehicle, including: a plurality of battery modules electrically interconnected with one another, where each battery module of the plurality of battery modules includes: a housing including a containment cavity that is pressure-sealed; an array of battery cells at least partially disposed within the containment cavity; a pipe containing fluid circulating within the pipe; and a liquid within the containment cavity; where a pressure within the containment cavity is dependent on an amount of thermal energy transferred between the liquid and at least a portion of a wall of the pipe.

Aspects of the above battery further include where fluid circulating within the pipe is on an outer side of the top surface of the housing and where the top surface includes the portion of the wall of the pipe or the top surface is in contact with the portion of the wall of the pipe. Aspects of the above battery further include where an interior surface of the housing includes dimples. Aspects of the above battery further include where each one of the dimples align in a vertical direction with each one of the battery cells in the array of battery cells. Aspects of the above battery further include a condenser connected to the pipe, where the fluid circulates through the condenser. Aspects of the above battery further include where a temperature of the fluid exiting the condenser is cooler than a temperature of at least one of the battery cells. Aspects of the above battery further include a heater pad adjacent to the base surface of the housing, where a temperature of the fluid is warmer than a temperature of at least one of the battery cells, and where a temperature of the heater pad is warmer than the temperature of the at least one of the battery cells. Aspects of the above battery further include where a portion of the pipe is within the containment cavity. Aspects of the above battery further include where the portion of the pipe is partially immersed within the liquid. Aspects of the above battery further include where a temperature of the fluid at an inlet of the portion of the pipe is lower than a temperature at an outlet of the portion of the pipe, and where the inlet is immersed within the liquid. Aspects of the above battery further include where an interior surface of the housing includes dimples. Aspects of the above battery further include where the interior surface is at least a portion of the top surface and at least a portion of the wall of the pipe that is not immersed in the liquid.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

The term “chemical properties” refer to one or more of chemical composition, oxidation, flammability, heat of combustion, enthalpy of formation, and chemical stability under specific conditions.

The terms “determine,” “calculate,” “compute,” and variations thereof, as used herein, are used interchangeably and include any type of methodology, process, mathematical operation or technique.

The term “thermal properties” refer to one or more of thermal conductivity, thermal diffusivity, specific heat, thermal expansion coefficient, and creep resistance.

The term “electrical insulator” refers to a material or combination of materials whose internal electrical charges do not flow freely; very little electric current will flow through the material(s) under the influence of an electric field. Electrical insulators have higher resistivity than semiconductors or conductors. The electrical insulator material(s) may be natural or synthetic.

What is claimed is:

1. A battery module, comprising:
a housing comprising a base surface, a top surface, and sidewalls extending from a periphery of the base surface,
wherein the sidewalls, the top surface, and the base surface define a containment cavity comprising a volume, and
wherein the housing is sized to receive a battery cell;
an array of battery cells at least partially disposed within the housing;
a pipe containing fluid circulating within the pipe; and
a liquid comprised within the housing, wherein an amount of the liquid is less than half of the volume, and
wherein thermal energy is transferred between an area within the housing and at least a portion of a wall of the pipe.

2. The battery module of claim 1, wherein the containment cavity is a pressure-sealed cavity.

3. The battery module of claim 2, wherein fluid circulating within the pipe is on an outer side of the top surface of the housing and wherein the top surface comprises the portion of the wall of the pipe or the top surface is in contact with the portion of the wall of the pipe.

4. The battery module of claim 3, wherein an interior surface of the housing comprises dimples.

5. The battery module of claim 4, wherein each one of the dimples align in a vertical direction with each one of the battery cells in the array of battery cells.

6. The battery module of claim 3, further comprising a condenser connected to the pipe, wherein the fluid circulates through the condenser.

7. The battery module of claim 6, wherein a temperature of the fluid exiting the condenser is cooler than a temperature of at least one of the battery cells.

8. The battery module of claim 3, further comprising a heater pad adjacent to the base surface of the housing, wherein a temperature of the fluid is warmer than a temperature of at least one of the battery cells, and wherein a temperature of the heater pad is warmer than the temperature of the at least one of the battery cells.

9. The battery module of claim 2, wherein a portion of the pipe is within the containment cavity.

10. The battery module of claim 9, wherein the portion of the pipe is partially immersed within the liquid.

11. The battery module of claim 10, wherein a temperature of the fluid at an inlet of the portion of the pipe is lower than a temperature at an outlet of the portion of the pipe, and wherein the inlet is immersed within the liquid.

12. The battery module of claim 11, wherein an interior surface of the housing comprises dimples.

13. The battery module of claim 12, wherein the interior surface is at least a portion of the top surface and at least a portion of the wall of the pipe that is not immersed in the liquid.

14. An energy storage device, comprising:
a housing comprising a base surface, a top surface, and sidewalls extending from a periphery of the base surface,
wherein the sidewalls, the top surface, and the base surface define a containment cavity, and
wherein the housing is sized to receive a battery cell;
an array of battery cells at least partially disposed within the housing;
a pipe containing fluid circulating within the pipe; and
a liquid and a void space within the housing, wherein at least a portion of each of the liquid and the void space is in contact with each battery cell in the array of battery cells, and
wherein thermal energy is transferred between each of the liquid and the void space and at least a portion of a wall of the pipe.

15. The energy storage device of claim 14, wherein the containment cavity is a pressure-sealed cavity.

16. The energy storage device of claim 15, wherein fluid circulating within the pipe is on an outer side of the top surface of the housing and wherein the top surface comprises the portion of the wall of the pipe or the top surface is in contact with the portion of the wall of the pipe.

17. The energy storage device of claim 16, further comprising a condenser connected to the pipe, wherein the fluid circulates through the condenser.

18. The energy storage device of claim 17, wherein a temperature of the fluid exiting the condenser is cooler than a temperature of at least one of the battery cells.

19. The energy storage device of claim 15, wherein a portion of the pipe is within the containment cavity, and wherein the portion of the pipe is partially immersed within the liquid.

20. A battery for an electric vehicle, comprising:
a plurality of battery modules electrically interconnected with one another, wherein each battery module of the plurality of battery modules comprises:
a housing comprising a containment cavity that is pressure-sealed;
an array of battery cells at least partially disposed within the containment cavity;
a pipe containing fluid circulating within the pipe; and
a liquid within the containment cavity;
wherein a pressure within the containment cavity is dependent on an amount of thermal energy transferred between the liquid and at least a portion of a wall of the pipe.
